(19) United States
(12) Patent Application Publication
(10) Pub. No.: US 2015/0104559 A1
(43) Pub. Date: Apr. 16, 2015

(54) BQQ Rub

(71) Applicant: Gary C. Woolfolk, Frisco, TX (US)

(72) Inventor: Gary C. Woolfolk, Frisco, TX (US)

(21) Appl. No.: 14/052,287

(22) Filed: Oct. 11, 2013

(51) Int. Cl. A23L 1/223

(52) U.S. Cl. CPC A23L 1/223; A23V 2002/00
USPC 426/650

(57) ABSTRACT

A composition to form a barbecue rub may include a first agent of salt, a second agent of sugar, a third agent of lemon pepper, a fourth agent of black pepper, a fifth agent of garlic powder, a sixth agent of onion powder, a seventh agent of smoked paprika, eight agent of chili powder and a ninth agent of Monosodium glutamate (MSG).

### FIELD OF THE INVENTION

This invention relates to food treatment and more particularly a flavorful condiment for example a barbecue rub useful for enhancing the flavor of meat and other foods, and in particular to a combination of ingredients process for providing a flavorful barbecue rub.

### BACKGROUND

Typical condiments include catsup, mustard, steak sauce, barbeque sauces, salad dressings, barbecue rub and the like. These condiments are primarily comprised of liquids and are generally available only in liquid form. There is a consumer need for dry, solid condiments such as a barbecue rub which provide the customer with greater convenience. Condiments such as steak sauces are often used outdoors where liquid sauces and glass bottling present greater disadvantages. A solid condiment avoids these disadvantages by providing a product that is dry, premixed, easily stored, conveniently shipped or transported, and easily mixed with the juices of the food (e.g., meat) or other aqueous liquid to provide a liquid sauce. The added convenience to consumers demonstrate the desireability of providing a dry, solid condiment including a barbecue rub.

It would be highly desirable to provide a product for enhancing the flavor of meat and other foods and a process for producing a dry flavor enhancing condiment useful to enhance the flavor of food such as steak.

U.S. Pat. No. 6,869,634 discloses a barbecue sauce being provided containing a mixture of vinegar, lemon juice, sage, red pepper, paprika, black pepper, white pepper, Worcestershire sauce, steak sauce, margarine, brown sugar, chili powder, garlic salt, onion salt, seasoning salt, meat tenderizer, tomato sauce and ketchup,

U.S. Pat. No. 5,501,867 discloses a composition suitable for use both as food preparation seasoning and non-stick base for cooking food items on a grill. The composition comprises an egg-based composition comprising egg yolk, distilled vinegar and soybean oil; a lemon juice comprising water, lemon juice concentrate, lemon oil and preservatives; a tomato paste comprising tomatoes, salt and citric acid; a salt-based composition comprising salt, yellow dyes, imitation butter flavor and preservatives; white vinegar; water; flavorings; a mustard-based composition comprising black mustard seeds, vinegar, white wine, salt and spices; paprika; and sugar. The composition is prepared by blending the above-listed ingredients at ambient temperature until they are all thoroughly blended. The composition is applied to food items prior to placing the food items on a grill for cooking. The composition can also be used as a marinating sauce on the food items.

U.S. Pat. No. 5,368,879 discloses a process for providing a flavorable composition for use as a food condiment. The composition is provided by extracting a mixture of steak sauce ingredients to provide a steak sauce extract separated from the extracted mixture of steak sauce ingredients. The steak sauce extract is heated in a pressure-controlled environment to above ambient pressure at a temperature above about 100.degree. C. The heat treated extract is then contacted with a substrate which is subsequently ground into powder form to provide a dry, powdered condiment useful as a steak sauce.

U.S. Pat. No. 5,063,073 discloses C-Gel food products comprising an aqueous gelatin kappa carrageenan matrix and a dispersed food product selected from the groups consisting of meat, seafood, vegetable, fruit, synthetic protein fiber, chocolate and mixtures thereof, in which the gelatin and carrageenan are present as a structurally firm continuous aqueous carrageenan/gelatin phase matrix at refrigeration temperature.

U.S. Pat. No. 4,741,914 discloses a flavor enhancing seasoning , which is prepared by blanching garlic, and extracting the blanched product with water. The extract produced may be deodorized and concentrated, to provide a seasoning additive that dramatically improves flavor fullness, depth and duration, and can be advantageously combined with flavor intensifiers such as MSG.

The above references are incorporated by reference in their entirety.

### SUMMARY

A composition to form a barbecue rub may include a first agent of salt, a second agent of sugar, a third agent of lemon pepper, a fourth agent of black pepper, a fifth agent of garlic powder, a sixth agent of onion powder, a seventh agent of smoked paprika, eight agent of chili powder and a ninth agent of Monosodium glutamate (MSG).

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a container and agents of the present invention.

### DETAILED DESCRIPTION

The composition including the barbecue rub in accordance with the present invention includes in one embodiment on a weight basis 45% salt, 26% sugar, 5% lemon pepper, 5.9% black pepper, 2.9% garlic powder, .88% onion powder, 6.5% smoked paprika, 2.6% chili powder and 2.5% MSG. The composition may include other elements or ingredients.

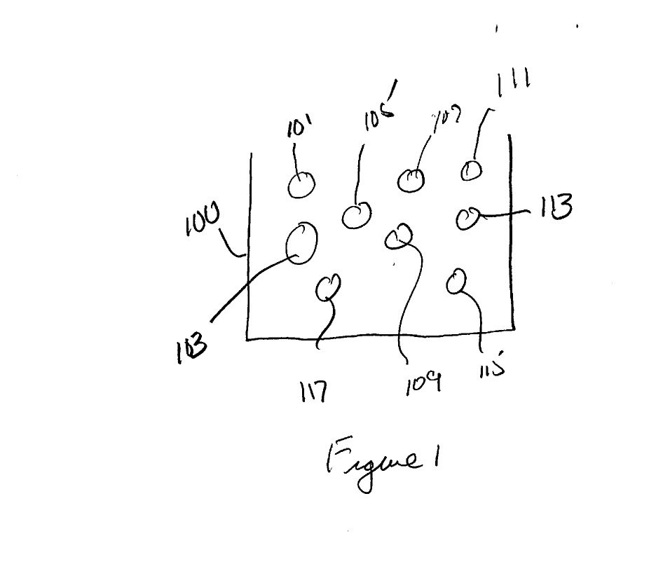

FIG. 1 illustrates a container 100 which may include a first agent 101 which may be salt, a second agent 103 which may be sugar, a third agent 105 which may be lemon pepper, a fourth agent 107 which may be black pepper, a fifth agent 109 which may be garlic powder, a sixth agent 111 which may be onion powder, a seventh agent 113 which may be smoked paprika, and eight agent 115 which may be chili powder and a ninth agent 117 which may be Monosodium glutamate (MSG). The first agent 101, the second agent 103, the third agent 105, the fourth agent 107, the fifth agent 109, the sixth agent 111, the seventh agent 113 and the eighth agent 115 may be all dry ingredients and may be mixed together in the container 100 to form a homogeneous composition.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A composition to form a barbecue rub, comprising:
a first agent of salt, a second agent of sugar, a third agent of lemon pepper, a fourth agent of black pepper, a fifth agent of garlic powder, a sixth agent of onion powder, a seventh agent of smoked paprika, eight agent of chili powder and a ninth agent of Monosodium glutamate (MSG).
